(19) United States
(12) Patent Application Publication
(10) Pub. No.: US 2004/0047533 A1
(43) Pub. Date: Mar. 11, 2004

(54) Device for contolling polarisation in an optical connection

(76) Inventor: Jean-Pierre Huignard, Paris (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/451,669

(22) PCT Filed: Dec. 20, 2001
(86) PCT No.: PCT/FR01/04114

(30) Foreign Application Priority Data
Dec. 28, 2000 (FR) 00 17226

(51) Int. Cl. G02B 5/30; G02B 6/00

(52) U.S. Cl. 385/11; 359/484

(57) ABSTRACT

The device of the invention essentially comprises a plate (6) of electrooptic material, for example PLZT, on which four electrodes (7 to 10) are printed. The electric field produced by applying voltages (V₁ to V₄) to these electrodes creates a rotating-axis phase plate.

The present invention relates to a polarization control device in an optical link.

Controlling the polarization in optical links will constitute a primary objective for future fiber networks operating at very high datarates employing wavelength multiplexing techniques. This is because a number of active components of fiber optic networks are sensitive to the state of polarization of the wave, particularly semiconductor or fiber amplifiers and LiNbO₃ external switches or modulators. The latter generally operate optimally with a linear incident polarization of the wave and, in addition, this polarization direction must be kept parallel to one of the electrooptic axes of the modulator. Moreover, one very important other application relates to polarization dispersion compensation.

Electrooptic polarization control devices are known, but they do not allow complete control of the polarization to be achieved, that is to say control of the rotation of the polarization axes and of the birefringence for each axis direction. Likewise, known optomechanical devices do not allow complete control and their reaction time is too long.

The subject of the present invention is a polarization control device in an optical link, which device allows both the rotation of the polarization axes and the birefringence for each axis direction to be controlled, which has a very short response time (for example of the order of 1 microsecond to about a few microseconds) and which is compact and introduces negligible insertion losses.

The device according to the invention comprises, in the optical link whose polarization it is desired to control, at least one block of electrooptic material having a birefringence that can vary under the action of an electric field, electrodes being placed on at least one face of this block and being connected to a circuit for varying the electrical voltages applied to these electrodes according to the desired rotation of the polarization axes.

The present invention will be more clearly understood on reading the detailed description of several embodiments, given by way of nonlimiting examples and illustrated by the appended drawing, in which:

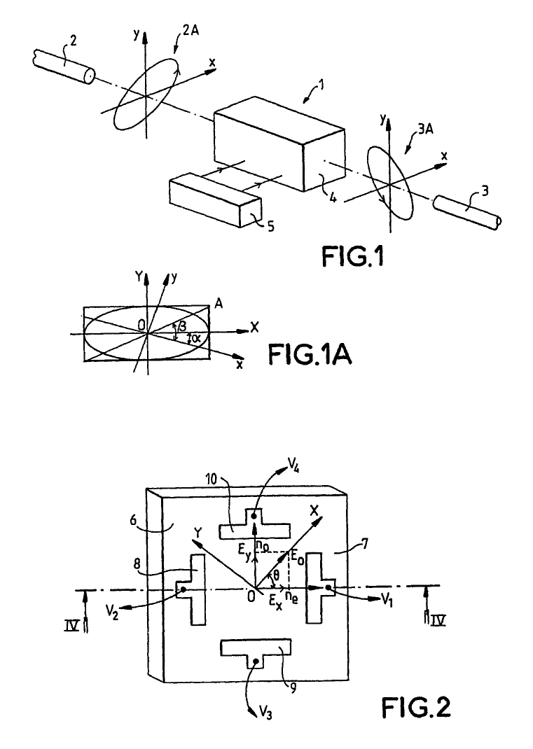

FIGS. 1 and 1A are a simplified view, in perspective, of a control device according to the invention, and a diagram showing the characteristics of optical wave polarization in the device of FIG. 1, respectively;

FIG. 2 is a plan view of a first embodiment of an electrooptic block that can be used in the device of FIG. 1;

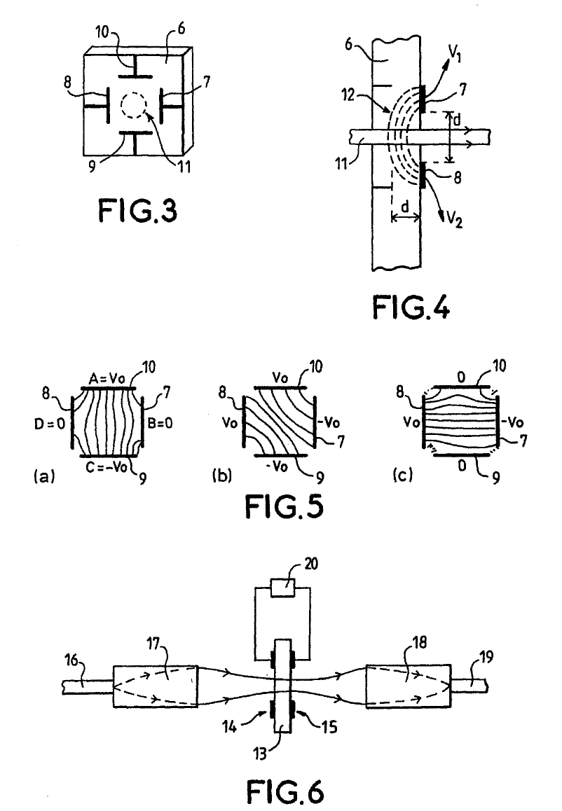

FIGS. 3 and 4 are a schematic front view and a schematic sectional view of the block of FIG. 2, respectively, the latter showing, in a simplified manner, the path of the electric field lines inside the block;

FIG. 5 is a set of three diagrams showing, in a simplified manner, the change in the electric field lines in the block of FIG. 2 according to various voltages applied to its electrodes;

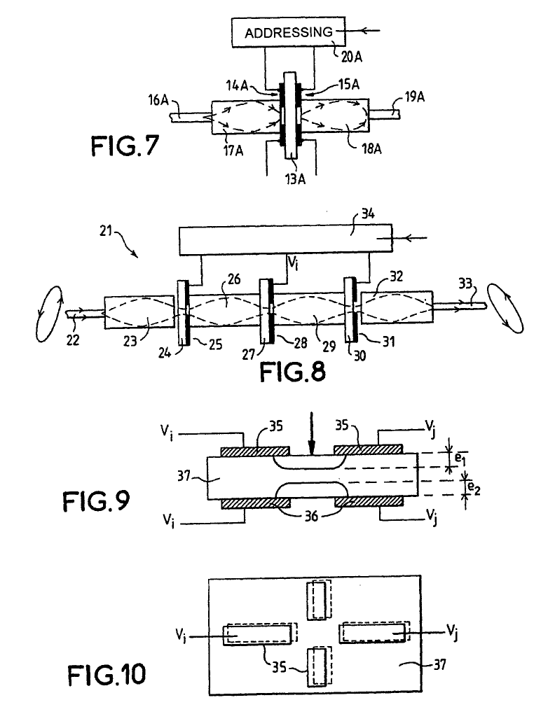

FIGS. 6 and 7 are diagrams of alternative embodiments of the block of FIG. 2;

FIG. 8 is a diagram showing the arrangement of three electrooptic blocks, according to the invention, in cascade;

FIGS. 9 and 10 are a sectional view and a plan view, respectively, of an alternative embodiment of the electrooptic block according to the invention, with electrodes placed on both opposed faces of the block;

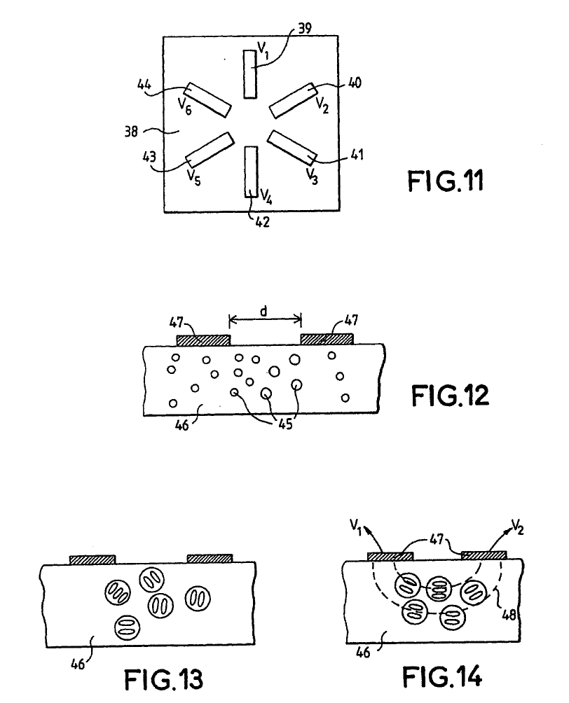

FIG. 11 is a plan view of another alternative embodiment of the electrooptic block according to the invention, with six electrodes; and

FIGS. 12 and 14 are schematic sectional views of another alternative embodiment of an electrooptic block according to the invention, with a material of the “PDLC” type.

The invention will be described below with reference to the control of the polarization of an optical wave propagating in the optical part (particularly in optical fibers) of a very high-datarate telecommunications network, but, of course, it is not limited to this single application, and it can be employed in many other applications in which it is desired to modify the polarization of an optical wave or to slave this polarization.

FIG. 1 shows schematically the essential elements of the device 1 of the invention. This device 1 is inserted in the path of an optical beam transported, in the present case, by optical fibers: an optical fiber 2 via which the optical beam, whose polarization 2A it is desired to treat, arrives and an optical fiber 3 via which the optical beam 3A, treated by the device 1, leaves. In order not to clutter up the drawing, the optical elements that couple the optical beam between the fibers 2 and 3 and the device 1 are not shown. This device 1 essentially comprises an electrooptic block 4 and electronic circuits 5 for addressing the electrodes of the block 4.

The block 4 is, for example, a rectangular parallelepipedal block of birefringent material able to compensate at each instant, owing to the action of an electric field, for any drift in the state of polarization of the optical beam emanating from the optical fiber 2. In the application in question (in this case, a telecommunications network), the changes in the state of polarization of the optical beam may be very rapid (variations over a few microseconds or milliseconds) and are due to variations in many parameters, particularly the temperature, the mechanical stresses imposed on the optical fibers, the reconfiguration of the network, etc. The device 1, with an electrooptic block as described below, makes it possible to obtain a very short response time (of the order of 1 microsecond to a few microseconds) with respect to the variations in polarization 2A of the optical beam.

The device 1 converts any form of polarization 2A into another form of polarization 2B. As shown in FIG. 1A, an elliptical form of polarization is characterized by two angles: α and β. The angle β is that defined by the axes Ox and OA (the diagonal of the rectangle circumscribing the ellipse). In other words, the device 1 controls the direction of the axis of the ellipse and its ellipticity independently, whatever the incident polarization 2A.

According to the prior art (see, for example, F. Heismann: “Analysis of a reset-free polarization controller for fast automatic polarization stabilization in fiber optic transmission systems”, Journal of Lightwave Technique, 12, 690, 1994 and F. Heismann and M. S. W. Whalen: “Fast automatic polarization control”, IEEE Photonics Tech.Lett. 4, 503, 1992), the polarization has to be controlled by a combination of birefringent plates, the rotation of the respective axes of which are controlled, which implies prohibitive response times. In contrast, the present invention uses an electrooptic block 4, in which it is sufficient to apply suitable electrical voltages to the electrodes thereof in order to control the direction of the axis and the birefringence of its material. This device 1 uses the free propagation of the optical beam.

The electrooptic material forming the block 4 is preferably a material whose Kerr coefficient has a high value (for example of the order of 10×10¹⁶ m²V⁻²) . This material is, for example, a PLZT (Pb-LA-Zn—TiO₂) ceramic. In general, when a transverse electric field generated by two electrodes placed on an electrooptic material is applied, a birefringent phase plate is obtained, the indices nₓ, n_{y} of which along two orthogonal axes Ox, Oy have respective values of:

$${n}_{x} = {n}_{o} + \frac{1}{2} {n}_{o}^{3 } {RE}^{2}$$

$${n}_{y} = {n}_{o}$$

in which expressions R is the Kerr coefficient of the material in question, E is the electrical voltage between the electrodes and nₒ is the index of the material in the absence of an electric field.

To obtain a rotating-axis phase plate function, a block 6 such as, for example, that shown in FIG. 2 is produced. This block is in the form of a thin rectangular parallelepiped, the large faces of which are square. Printed on or fixed to one of the large faces of the block 6 are four identical electrodes, for example 7 to 10. These electrodes have a “T” shape and their “horizontal” branches define a square at the center of the large face. The electrodes 7 to 10 are connected to electrical potentials V1 to V4, respectively. The rotating-axis phase plate function is obtained by applying a rotating electric field to the electrodes 7 to 10 (see for example P. Joffre: Thesis “[Liquid-crystal electrooptic microstructures and applications]”, INPG, 1991). This rotating field is produced by applying, on the one hand, a potential difference V1-V2 between the pair of opposed electrodes 7 and 8 and, on the other hand, a potential difference V3-V4 between the pair of opposed electrodes 9 and 10, these potentials varying. FIG. 3 shows the trace 11 of the optical beam emanating from the fiber 2 and FIG. 4 shows the electric field lines produced by two opposed electrodes, for example 7 and 8. FIG. 5 shows three examples of electric field lines created for three different combinations of potentials applied to the electrodes 7 to 10.

Respectively, from left to right in FIG. 5, the following potentials are applied to these electrodes 7 to 10:

(a):0,0,−Vₒ,Vo

(b):−Vo,−Vo,−Vo,Vo

(c):−Vo,Vo,0,0.

Depending on these three cases, the field lines are, at the center of the square defined by the electrodes 7 to 10, approximately vertical (as seen in the drawing), approximately parallel to one diagonal of the square, and approximately horizontal. Thus, near the center of the block 6 the equivalent of an electric field rotating with respect to its center is obtained to a good approximation. This field thus produces the function of a phase plate, the rotation θ of the axis Ox of which follows the rotation of the field. The block 6 may be called a “modulator”—it modulates the polarization of the incident beam emanating from the fiber 2. The optical index values nₓ and n_{y} along the Ox and Oy axes (see FIGS. 1A and 2) of the optical beam in the plane of incidence on the block 6 are:

$$\{ \begin{matrix}{n}_{x} = {n}_{o} + \frac{1}{2} {n}_{o}^{3} R [ {Ex}^{2} + {Ey}^{2} ] \\ {n}_{y} = {n}_{o }\end{matrix} \\ where Ex = \frac{{V}_{2} - {V}_{1}}{d} , Ey = \frac{{V}_{3} - {V}_{2}}{d} \\ and tan θ = \frac{Ey}{Ex} .$$

In these expressions:

θ is the angle between the axis Ox of the ellipse of the beam to be controlled (or corrected) and the axis of the block 6 passing through the centers of the electrodes 7 and 8 (reference axis \vec{OEx});

d is the distance between the electrodes 7 and 8 or 9 and 10 (assumed to be arranged symmetrically with respect to the center O, on which the incident optical beam is centered);

R is the Kerr coefficient of the material of the block 6; and

nₒ is the optical index of the block 6 along Oy.

The phase modulator function of the block 6, exerted inside the square defined by the electrodes 7 to 10 and more particularly near its center, is equivalent to a phase plate with the axis rotating through an angle θ and with a variable birefringence Δφ. These parameters are given by the following equations as a function of the voltages V₁ to V₄ to be applied to the electrodes 7 to 10:

$$θ = arctan \frac{{V}_{4} - {V}_{3}}{{V}_{2} - {V}_{1}}$$

$$Δϕ = \frac{2 π}{λ} . d \frac{1}{2} {n}_{o}^{3} \frac{R}{{d}^{2}} [ {( {V}_{2} - {V}_{1} )}^{2} + {( {V}_{3} - {V}_{2} )}^{2} ] .$$

The axis of the phase plate thus obtained rotates at an angular velocity Ω defined by the following equations:

$${V}_{4} - {V}_{3} = Vo cos Ω t , {V}_{2} - {V}_{1} = Vo sin Ω t$$

$$and Δϕ = \frac{π}{λ} \cdot {n}_{o}^{3} \cdot \frac{R}{d} \cdot {V}_{o}^{2} .$$

In practice, the block 6 may be made in various ways. A first embodiment consists in using a thin disk of PLZT ceramic having a composition suitable for electrooptic applications. For example, the composition of this ceramic may be Pb₁₋ₓLaₓZr_{y}Ti_{1-y}O₂ where x=0.09 and y=0.65. This ceramic has a high Kerr coefficient with negligible hysteresis. Deposited on one of the faces of this ceramic (the entrance face for the beam to be corrected) are two pairs of electrodes (7-8 and 9-10), for example by a vacuum deposition of metal. These electrodes may be made of Au or Al, for example.

In one embodiment, the values of the parameters mentioned above were the following:

D=100 μm, λ=1.5 μm, R=10.10¹⁶ m^{2 V}−2, nₒ=2.5.

A half-wave plate (Δφ=π) for Vₒ=100 V and a quarter-wave plate (Δφ=π/2) for Vₒ=50 V are obtained.

The typical response time of ceramic optooelectric devices is of the order of 1 μs. The block is obtained from a polished PLZT substrate, the thickness of which is about 0.5 to 1 mm. Recently, methods for depositing PLZT films by “sol-gel” techniques or by liquid epitaxy have been developed for producing large-size components (for example greater than 5 cm²). As indicated in FIG. 6, two electrooptic functions may be produced, for example λ/2 and λ/4 plates with rotating axes on each face of the electrooptic ceramic substrate 13. Printed on each face of this substrate are electrodes which have, for example, the same configuration as that shown in FIG. 2. These electrodes are referenced 14 in their entirety on one face of the substrate 13, and 15 in their entirety on the other face. A monomode optical fiber 16, terminating in a focusing optic 17 (for example a graded-index microlens), sends an optical beam to the center of the face of the substrate 13 carrying the electrodes 14, while the beam emanating from the other face of the substrate is collected by the optic 18 (similar or identical to the optic 17) coupled to an output monomode optical fiber 19. The electrodes 14 and 15 are controlled by a circuit 20 so as to form, for example, on the side with the electrodes 14, a rotating-axis λ/4 plate and, on the side with the electrodes 15, a rotating-axis λ/2 plate. Of course, other combinations of phase plates may thus be produced.

FIG. 7 shows a compact variant of the device shown in FIG. 6, this variant using components similar to those of FIG. 6 and these have been assigned the same numerical references but each followed by an “A”. The control circuit 20A, like the circuit 20, controls the two modulators having the electrodes 14A and 15A, respectively, so as to achieve an endless operation of the two modulators (without a stop for the rotating axis).

To best satisfy the operational constraints that require, in high-datarate telecommunications applications, for example, the state of polarization of the network to be followed and reconfigured rapidly, it is possible to use a device such as the device 21 shown in FIG. 8. This device 21 receives an optical beam from an optical fiber 22 that terminates in a focusing optic 23 placed beside a first modulator 24 carrying a set of electrodes 25. The modulator 24 is followed by a second focusing optic 26, a second modulator 27 carrying electrodes 28, a third focusing optic 29, a third modulator 30 carrying electrodes 31, and a fourth focusing optic 32 coupled to an output optical fiber 33. The modulators 24, 27 and 30 are, for example, of the type of the modulator shown in FIG. 2. The electrodes 25, 28 and 31 are connected to a control circuit 34. Each of the modulators 24, 27 and 30 acts as an electrooptic phase plate. Each of these plates allows its axes to be electrooptically rotated and/or allows its birefringence to be electrooptically controlled for each axis direction, in order to constitute an electrooptic assembly of variable birefringence and variable orientation. The control circuit 34 applies voltages to the various sets of electrodes 25, 28 and 31, making it possible to produce, in a manner known per se, the function of controlling the polarization of the incident beam.

The material of which the electrooptic block of the invention is made may be not only PLZT, but any material having a high electrooptic coefficient (Kerr coefficient) . For example, this may be a ceramic such as PbSZT, BLTN, SBN, etc., or else an electrooptic polymer layer, or a liquid-crystal device (but it should be noted that the liquid crystals have too long a response time, much longer than a few us), or else a PDLC (Polymer Dispersed Liquid Crystal), described below with reference to FIGS. 12 to 14.

FIGS. 9 and 10 show an alternate embodiment of the modulator device of the invention, for which identical electrodes 35, 36 are placed on the two faces of an electrooptic substrate 37. This variant is used here not for combining two phase plates (λ/4 and λ/2 for example) but to increase the efficiency of the modulator. This is because each configuration of electrodes 35, 36 is controlled by the same combination of voltages that is applied to these electrodes 35, 36 and has an “active thickness” (in FIG. 9, e1, e2 respectively), that is to say the thickness of electrooptic material measured from the plane of the electrodes, for which thickness the electric field created by these electrodes is effective with respect to controlling the polarization of the optical beam passing through the substrate 37. Thus, instead of having a single active thickness e1 or e2, the two combine to control the polarization.

Another alternative embodiment of the device of the invention is shown in FIG. 11. In this embodiment, the number of electrodes formed on one face of a substrate 38 is greater than four. In the embodiment shown in FIG. 11, this number is six. These electrodes are referenced 39 to 44 and they are arranged uniformly about the center of the face of the substrate 38, thus defining a hexagon. Because of this larger number of electrodes, when a lower voltage is applied to each electrode (lower than in the case of four electrodes), the resulting electric field obtained at the center of the hexagon is both higher and more uniform. The complexity of the device for controlling the electrodes is greater than in the case of a four-electrode configuration. Of course, it will be conceivable to place an even larger number of electrodes on the face of an electrooptic substrate, but the complexity of the electrical control device would be even greater. It is therefore necessary for each application to find a compromise between the complexity of the control device and the effectiveness of the modulator.

According to yet another alternative embodiment of the device of the invention, the material forming the PLZT-type electrooptic block is replaced with a particular PDLC material called a “nanodroplet” material.

This material, illustrated schematically in FIGS. 12 to 14, comprises liquid-crystal droplets 45 incorporated into a polymer matrix 46 (FIG. 12) by a rapid curing process, for example using UV irradiation. It is then possible to obtain liquid-crystal droplets whose size is well below 1 μm. Although the medium thus obtained is inhomogeneous and the index of the liquid crystal and of the polymer are different, the medium is not at all scattering. This is because, in the present case, the size of the droplets 45 is much smaller than the wavelength of the optical beam passing through the medium. The material therefore behaves just as if it were an isotropic electrooptic ceramic. The electrooptic effect in this case results from the reorientation, under the action of an electric field, of the liquid-crystal molecules present in the droplets. This phenomenon is illustrated in FIGS. 13 and 14. FIG. 13 shows schematically a few molecules of liquid crystal which, in the absence of an electric field, are randomly oriented. When an electrical voltage is applied to the electrodes 47, an electric field is created in the medium 46 and the molecules are in parallel to the electric field lines 48.

The birefringence of this PDLC device is of the order of a few 10⁻³ for voltages applied to the electrodes 46 of the order of a few tens to about a hundred volts, the interelectrode space (d) being of the order of 100 μm. The response times obtained with this type of material are of the order of about ten to a few tens of ps for material thicknesses of a few hundred μm.

1. A polarization control device in an optical link, characterized in that it comprises, in the optical link whose polarization it is desired to control, at least one block of electrooptic material (6, 13, 13A, 24, 27, 30, 37 ,38 ,46) having a birefringence that can vary under the action of an electric field, electrodes (7 to 10, 14, 15, 14A, 15A, 25, 28, 31, 35, 36, 39 to 44, 46) being placed on at least one face of this block and being connected to a circuit (5, 20, 34) for varying the electrical voltages applied to these electrodes according to the desired rotation of the polarization axes.

2. The device as claimed in claim 1, characterized in that the electrooptic material is isotropic in the absence of an applied electric field, the orientation of the neutral axes of said material and the birefringence of said material both being able to be controlled by the electric field.

3. The device as claimed in claim 2, characterized in that the electrooptic material is one of the following materials: PLZT, PbSZT, BLTN, SBN, electrooptic polymer layer, liquid crystals and “nanodroplet” PDLC.

4. The device as claimed in one of the preceding claims, characterized in that the electrooptic block (13, 13A) has, on each of its main faces, electrodes (14, 15, 14A, 15A) that define a rotating-axis phase plate on each of these faces.

5. The device as claimed in any one of the preceding claims, characterized in that it comprises several blocks in cascade along the same optical path (26, 29, 32), each of these blocks being provided with electrodes (25, 28, 31) so as to achieve no-stop control of the polarization.

6. The device as claimed in one of the preceding claims, characterized in that the polarization control is the slaving of a polarization direction of an optical beam.
